(19) United States
(12) Patent Application Publication
(10) Pub. No.: US 2015/0116079 A1
(43) Pub. Date: Apr. 30, 2015

(54) ENHANCED VEHICLE KEY FOB

(71) Applicant: GM Global Technology Operations LLC, Detroit, MI (US)

(72) Inventors: Pradyumna K. Mishra, Birmingham, MI (US); Mark S. Frye, Grosse Pointe Woods, MI (US)

(73) Assignee: GM Global Technology Operations LLC, Detroit, MI (US)

(21) Appl. No.: 14/062,200

(22) Filed: Oct. 24, 2013

(51) Int. Cl. G07C 9/00

(52) U.S. Cl. CPC G07C 9/00007; G07C 9/00087
USPC 340/5.52; 340/5.61

(57) ABSTRACT

An enhanced vehicle key fob includes a controller that is coupled to a power source, an antenna, and an accelerometer that measures the acceleration of the enhanced vehicle key fob and outputs the measurement to the controller, wherein the enhanced vehicle key fob controls a vehicle function of a vehicle using the output of the accelerometer.

### TECHNICAL FIELD

The present invention relates to vehicles and more particularly wireless vehicle key fobs.

### BACKGROUND

Vehicles have traditionally required a set of keys for gaining access to vehicle functions. In the past, these keys have been fashioned out of metal and inserted into mechanical locks. However, modern vehicles commonly use wireless key fobs to control vehicle functions. Using short-range wireless signals between the vehicle key fob and the vehicle, the key fob can remotely control a number of vehicle functions. For example, when a user or vehicle owner approaches a vehicle and wants to unlock the doors, the user can depress a button on the key fob that causes the transmission of a wireless signal to the vehicle causing the unlocking of the doors. Other vehicle functions can also be controlled, such as vehicle locking, trunk opening, or the flashing of exterior lights.

In addition to wireless vehicle key fobs, vehicle owners now carry a wide array of other personal electronic devices. For example, vehicle owners have increasingly begun carrying handheld wireless devices that have cellular communication capabilities, such as smartphones. Besides smartphones, vehicle owners choose to carry other devices as well. Some vehicle owners carry “quantified self” devices that can monitor the activity and sleep patterns of the user. A user that carries each device must keep track of a plurality of devices, which increases the probability that one will be lost or forgotten.

### SUMMARY

According to an embodiment of the invention, there is provided an enhanced vehicle key fob that includes a processor that is coupled to a power source and an accelerometer that measures the acceleration of the enhanced vehicle key fob and outputs the measurement to the processor, wherein the enhanced vehicle key fob controls a vehicle function of a vehicle using the output of the accelerometer.

According to another embodiment of the invention, there is provided a method of controlling a vehicle function with an enhanced vehicle key fob. The method includes defining a bodily motion the execution of which is both detectable by an accelerometer and causes a status change in a vehicle function; associating the bodily motion with one or more vehicle functions; detecting one of the defined bodily motions at the enhanced vehicle key fob using the accelerometer; identifying the vehicle function associated with the detected bodily motion; and controlling the vehicle function.

According to another embodiment of the invention, there is provided a method of authenticating a user of an enhanced vehicle key fob. The method includes measuring movement by a user carrying the enhanced vehicle key fob using an accelerometer included with the vehicle key fob; recording the measured movement of the user at the enhanced vehicle key fob; determining one or more periodic attributes of the recorded movement; measuring movement by a different user using the accelerometer; comparing the movement by the different user with the periodic attributes of the recorded movement; and controlling one or more vehicle functions when the movement by the different user is beyond a predefined threshold of the periodic attributes.

According to another embodiment of the invention, there is provided a method of using an enhanced vehicle key fob having an accelerometer to detect vehicle key loss. The method includes detecting that an increase in acceleration at the enhanced vehicle key fob using the accelerometer is above a first threshold; detecting that a decrease in acceleration at the enhanced vehicle key fob using the accelerometer is above a second threshold; determining that both the increase and decrease in acceleration occurred within a predefined amount of time; and activating an alert at the enhanced vehicle key fob that informs a user that the vehicle key fob has been lost.

According to another embodiment of the invention, there is provided a method of locally monitoring human vital signs of a vehicle occupant using a enhanced vehicle key fob. The method includes establishing a human vital sign threshold; associating the human vital sign threshold with a vehicle function; measuring one or more human vital signs using the enhanced vehicle key fob; comparing the measured human vital sign with the established human vital sign threshold; and controlling the vehicle function associated with the human vital sign threshold when the measured human vital sign exceeds the established human vital sign threshold.

According to another embodiment of the invention, there is provided a method of converting audio generated at a vehicle into haptic information using an enhanced vehicle key fob. The method includes associating information played audibly at the vehicle with a haptic output that represents the information; receiving at the enhanced vehicle key fob a signal indicating audible information is played at the vehicle; generating the haptic output representing the audible information at the enhanced vehicle key fob.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of using the devices and methods disclosed herein;

FIG. 2 is an exploded view of one embodiment of an enhanced vehicle key fob;

FIG. 3 is an embodiment of a method of controlling a vehicle function with a vehicle key fob;

FIG. 4 is an embodiment of a method of authenticating a user of the enhanced vehicle key fob;

FIG. 5 is an embodiment of a method of using an accelerometer of the enhanced vehicle key fob to detect enhanced vehicle key fob loss;

FIG. 6 is an embodiment of a method of locally monitoring human vital signs of an enhanced vehicle key fob user; and

FIG. 7 is an embodiment of a method of converting audio generated at the vehicle into haptic information using the enhanced vehicle key fob.

### DETAILED DESCRIPTION OF THE ILLUSTRATED EMBODIMENTS

The systems and methods described below involve an enhanced vehicle key fob that integrates the elements and functionality of vehicle key fobs with that of quantified-self devices. That is, in addition to controlling vehicle functions, such as door locking/unlocking, the enhanced vehicle key fob can also monitor the motion of the a person carrying the key fob or that person's vital signs. The enhanced vehicle key fob can be a wearable item such that the fob contacts the skin of its user or in close proximity to the skin, such as when it is placed into a pocket. A combination of wireless communication, motion monitoring, and vital sign detection can permit the enhanced vehicle key fob to communicate between the user and a vehicle in novel ways. In one example, the enhanced vehicle key fob can detect pre-defined bodily motions of the user and discern a command from the detected bodily motion. Apart from the pre-defined bodily motions of the user, other motions of a user carrying the enhanced key fob can be measured and used to identify who is carrying the key fob. Depending on the determined identity of the person carrying the enhanced key fob, access to vehicle functions can be selectively permitted and the vehicle can be personalized and appropriately configured immediately prior to the driver boarding the vehicle.

The enhanced vehicle key fob can carry out other functions as well. Using its ability to detect motion, the enhanced vehicle key fob can detect sharp increase in acceleration closely followed by sharp decreases in acceleration to predict when someone carrying the enhanced vehicle key fob has dropped it. In response, the enhanced vehicle key fob can initiate an alert (visual, audible, haptic, or any combination of these) to gain the attention of the user. Apart from its motion-sensing capabilities, the enhanced vehicle key fob can locally monitor the vital signs of the person carrying it (or wearing it). For instance, the enhanced vehicle key fob can monitor the heart rate, pulse, temperature, or other similar vital sign and based on the levels of these vital signs, the key fob can change the operational settings of vehicle systems or vehicle functions. The enhanced vehicle key fob can also listen for audibly-played information in a vehicle, identify the audible information, and convert the information to pre-defined haptic feedback that can be felt by the user carrying the key fob. The haptic feedback can be understood by users with poor hearing or in noisy environments and ensure that audibly-given information is not ignored.

### Communications System—

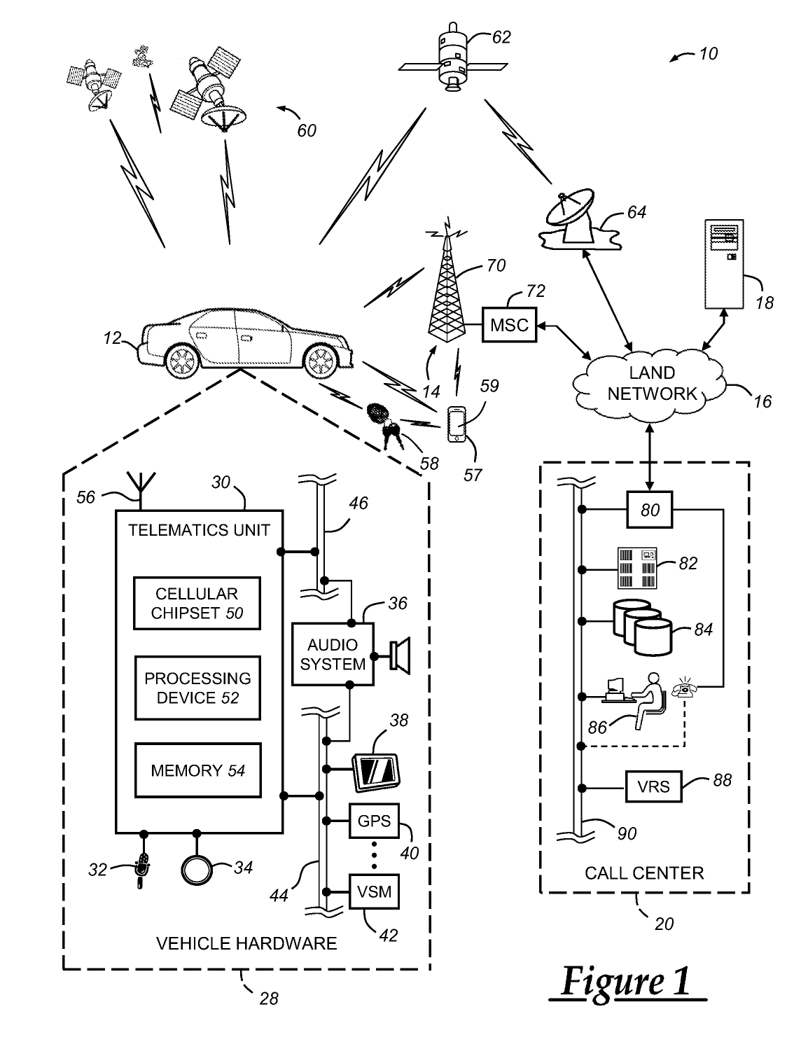

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

One of the networked devices that can communicate with the telematics unit 30 is a separate wireless device, such as a smart phone 57. The smart phone 57 can include computer processing capability, a transceiver capable of communicating using a short-range wireless protocol, and a visual smart phone display 59. In some implementations, the smart phone display 59 also includes a touch-screen graphical user interface and/or a GPS module capable of receiving GPS satellite signals and generating GPS coordinates based on those signals. Examples of the smart phone 57 include the iPhone™ manufactured by Apple, Inc. and the Droid™ manufactured by Motorola, Inc. as well as others. These and other similar devices may be used or considered as a type of separate wireless device for the purposes of the method described herein. While the smart phone 57 is described with the methods below, it should be appreciated that other similar and/or simpler handheld wireless device can be successfully substituted for the smart phone 57 to carry out the method/system described herein. For instance, devices such as the iPad™ or iPod Touch™ can also use the short-range wireless protocols to communicate despite not having the capability to communicate via cellular protocols.

An enhanced vehicle key fob 58 is also shown having a protective housing and including a combination of electronic components designed to receive signals from switches, process the signals, and wirelessly transmit command signals to vehicle 12. The enhanced vehicle key fob 58 can also wirelessly communicate with the smartphone 57. For the enhanced vehicle key fob 58 shown here, it is configured to be attached to mechanical keys and placed in a pocket or a purse; however, it should be appreciated that the key fob 58 could be configured in a variety of different forms and is not limited to the illustrative example shown here. For instance, the vehicle key fob 58 can be a device that is wearable, similar to a bracelet or a wristwatch. A power source (not shown) generally provides vehicle key fob 10 with electrical power and can include any type of appropriate battery or other power providing component known in the art. More details of the enhanced vehicle key fob 58 will be discussed below.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Enhanced Vehicle Key Fob Architecture—

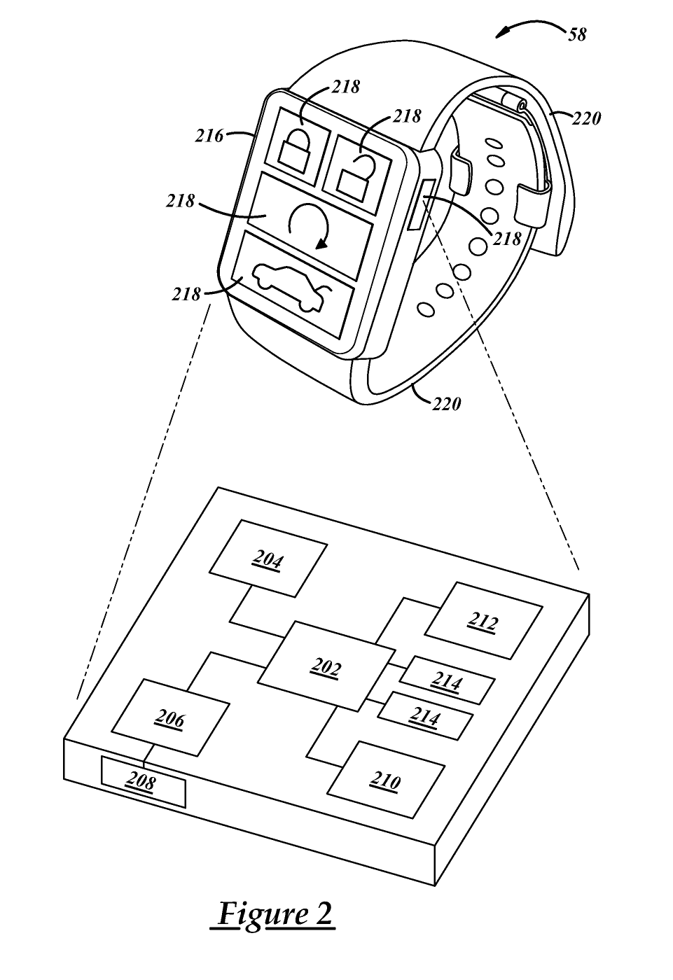

Turning to FIG. 2, an exemplary implementation of the enhanced vehicle key fob 58 is shown. In this implementation, the enhanced vehicle key fob 58 includes a processor 202, a memory device 204, a power source 206, an external port 208 for receiving charge, an accelerometer 210, a vibrating electric motor 212, one or more sensors 214, an enclosure 216, and a plurality of switches 218 located on the enclosure 216. These elements can be communicatively linked via a printed circuit board (PCB) or other similar electrically-communicative circuit-rendering implementation. While the enhanced vehicle key fob 58 is shown with straps 220 for wearing the key fob 58 in a way similar to how a person would wear a wristwatch, it should be appreciated that in other implementations of the enhanced vehicle key fob 58 includes forming the key fob 58 into a bracelet or a strap-less device designed to be put in a pocket or a purse like a traditional key fob, as is shown in FIG. 1. It is also possible that at least a portion of the enhanced vehicle key fob can be separated from a mechanical emergency key that is attached to the key ring and could be worn as a wearable device on wrist, belt, pocket, or similar locations to control the vehicle 12 as well as act as an activity tracker for fitness.

The processor 202 (also referred to as a controller) of the enhanced vehicle key fob 200 can control the operation of the key fob 58 and be programmed to carry out a number of customizable algorithms, the content of which will be discussed in more detail below. While the processor 202 itself can include dedicated memory that includes computer-readable instructions, those instructions can also be accessible from the memory device 204 that is separate from the processor 202. One example of processor 202 is a Nordic nRF51822 processor configured to carry out Bluetooth Low Energy (LE) communication protocols and ultra-low energy 2.4 GHz wireless communications. The processor 202 can use the Bluetooth LE capabilities to communicate with a variety of external sources, such as the smartphone 57 and the vehicle 12 as well as Wi-Fi hotspots (not shown). It should be appreciated that other Wi-Fi bandwidths can also be used, such 5 GHz. Using these communications capabilities, the processor 202 can also oversee over-the-air (OTA) software updates at the enhanced vehicle key fob 58. It is also possible to use the smartphone 57 and the Bluetooth capabilities to locate the enhanced vehicle key fob 58 and cause it to make noise or otherwise alert the user or indicate the location of the key fob 58. By measuring the wireless signal strength generated by the enhanced vehicle key fob 58, the smartphone 57 can determine a range to the key fob 58 and also send a wireless signal via a short-range wireless protocol commanding the device to make sound. In this implementation, the processor 202 includes 256 kilobytes (KB) of flash memory and 16 KB of random access memory (RAM). The processor 202 is communicatively and electrically linked to the power source 206. Depending on the particular processor 202 and other hardware, the voltage and current ratings of the power source 206 may differ. But in one embodiment, the power source 206 can be a lithium-ion (Li-Ion) battery rated at 3.7 Volts (V) and 130 milliamp hours (mAH). In addition, an external port 208 can be used for receiving power that can be applied to the power source 206 and/or be used to power the processor 202 and other components. A linear voltage regulator (not shown) can be used between both the power source 206/external port 208 and the processor 202. An example of such a voltage regulator is manufactured by Texas Instruments (TI) model number TPS73633. In one implementation, the external port 208 can be configured to receive universal serial bus (USB) port plugs through which power can be applied and/or data can be communicated. However, other commercially-known ports are known and can be implemented.

The accelerometer 210 can be communicatively linked to the processor 202 such that the accelerometer 210 sends the processor 202 output or data and receives from the processor 202 operating instructions. As the enhanced vehicle key fob 58 moves, the accelerometer 210 can create precise data reflecting this movement and output the data in a form readable by the processor 202. The output received by the processor 202 and the instructions sent to the accelerometer 210 can be communicated using a serial peripheral interface (SPI) bus. Any one of a number of commercially-available three-axes linear accelerometers can be used, such as an LIS3DH model manufactured by STMicroelectronics. The accelerometer 210 can also include a gyroscope for measuring angular movement. In one implementation, the gyroscope is included with the accelerometer 210. However, it should be appreciated that the accelerometer can be a stand-alone component. For purposes of the description herein, the data generated by the accelerometer 210 can also be viewed as including an angular component generated by a gyroscope.

The vibrating electric motor 212 can be directed by the processor 202 to provide haptic feedback to a user who carries the enhanced vehicle key fob 58. In one example, the vibrating electric motor 212 can communicate with the processor 202 via a single serial-ended bus, such as an inter-integrated circuit (I²C) bus. And the vibrating electric motor can be implemented using a Texas Instruments TI DRV2605 haptic driver.

The enhanced vehicle key fob 58 can also include one or more sensors 214 in addition to the accelerometer 210 that can provide information gathered at the key fob 58 to the processor 202. Examples of these sensors 214 include temperature sensors, pulse-rate sensors, and light sensors, to name a few. Like the accelerometer 202, the sensors 214 can pass information/data to the processor 202 using an SPI bus.

The elements above are protectively housed by the enclosure 216 that carries a plurality of switches 218 for controlling vehicle functions. The enclosure 216 serves to protect the components of the enhanced vehicle key fob 58 described above and can be configured into a variety of shapes using materials such as plastic, metal, and glass. In one embodiment, the size of the enclosure is less than 40 millimeters (mm) long by 40 mm wide. The switches 218 can be located on an exterior surface of the enclosure 216 so that they can be actuated by the user carrying the enhanced vehicle key fob 58. In that sense, the switches 218 can be momentary switches that are actuated by pressing an exterior surface of the enclosure 216. Or in another example, the enclosure 216 can include a plurality of apertures through which switches 218 can pass in a way that the switches 218 are in communication with the processor 202 within the enclosure 216 but also accessible by a user from the outside of the enclosure 216. It should also be appreciated that other types of switches are possible, such as toggle-type switches or switches that are virtually shown on a display, such as one made from liquid crystals (e.g., an LCD).

Methods of using the Enhanced Vehicle Key Fob—

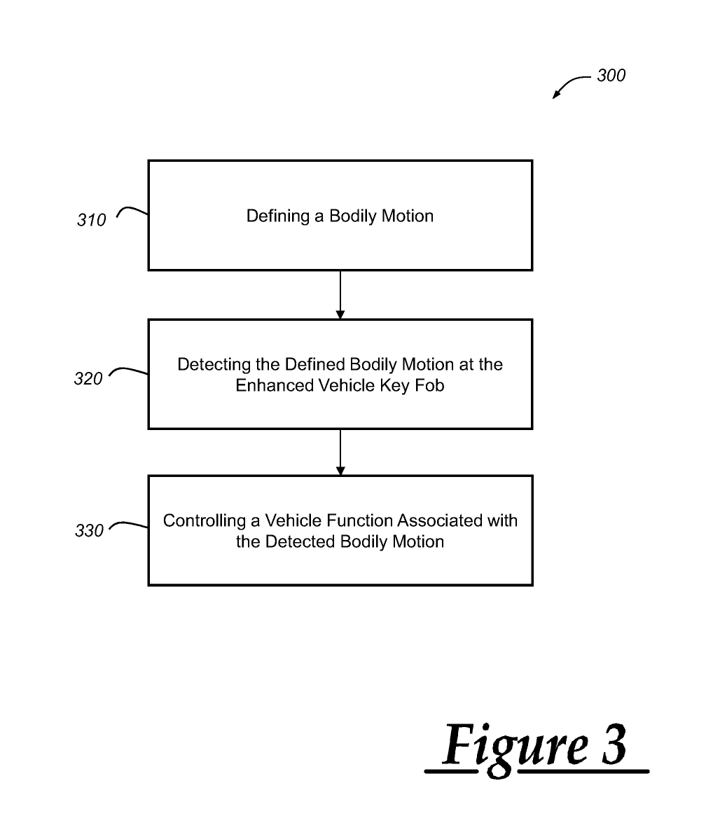

Turning now to FIG. 3, there is shown a method 300 of controlling a vehicle function with the enhanced vehicle key fob 58. The method 300 begins at step 310 by defining a bodily motion the execution of which is both detectable by the accelerometer 210 and causes a status change in a vehicle function. The associated bodily motion can then be associated with one or more vehicle functions. A wide variety of vehicle functions can be associated with bodily motion. Examples of vehicle functions include, locking/unlocking vehicle doors, opening trunk lids, activating exterior illumination, activating vehicle alarms, causing the vehicle honk its horn, activating/deactivating Wi-Fi hotspots at the vehicle 12, opening/closing windows, or other similar actions carried out using the vehicle 12.

A user can move the enhanced vehicle key fob 58 in a particular pattern, the key fob 58 can detect this movement, and one or more vehicle functions can be controlled in response to the movement. For example, the enhanced vehicle key fob 58 can be programmed to detect output from the accelerometer 210 that reflects a pattern of user movement, such as the user moving the key fob 58 two times in an up-and-down motion. The two times up-and-down movement can be identified as a defined bodily motion. Then, the up-and-down motion executed two times (i.e., the defined bodily motion) can then be associated with locking and unlocking the doors (i.e., the vehicle function). As a result, if a user of the enhanced vehicle key fob 58 wants to unlock the door of the vehicle 12, the user can execute the defined bodily motion (e.g., two up-and-down motions).

The defined bodily motions can be detected by the enhanced vehicle key fob 58 not only when they are carried out using a user's hand/arm combination to execute the motion but also a motion of the user's leg while the key fob 58 is located in his/or her pocket. In that case, the user could stomp his or her foot twice to execute the two up-and-down motions that would be recognized by the enhanced vehicle key fob 58. While this example is described with respect to an up-and-down movement that is done twice, the movement shape as well as the number of times the movement is carried out are highly customizable and many different combinations can be used in order to differentiate one defined bodily motion from another. For instance, the defined bodily motion can be circular rather than up-and-down and could be completed less frequently (e.g., once) or more frequently (e.g., three times). In another example, the defined bodily motion can include raising one hand with the enhanced vehicle key fob 58 held high causing the panic alarm to trigger. And in another example, a horizontal sweep of the hand from the right side to the left (or vice versa) can cause the car horn to trigger in a non-panic mode to alert the driver of the location of the car in a parking building for instance.

Using the different defined bodily motions, one vehicle function can be assigned to one defined bodily motion, such as the two up-and-down motions to unlock doors while another vehicle function can be attributed to a second defined bodily motion, such as using three up-and-down motions to open the trunk lid. As can be appreciated from this description, many different combinations of movement and vehicle functions are possible. It is also possible to incorporate multiple vehicle functions with one defined bodily motion. For instance, the two up-and-down motions can be associated not only with unlocking the doors of the vehicle 12 but also illuminating exterior vehicle lights as well. In that way, two different vehicle functions can be controlled with one bodily motion. The method 300 proceeds to step 320.

At step 320, one of the defined bodily motions is detected at the vehicle key fob 58 using the accelerometer 210. Once one or more defined bodily motions have been established along with the vehicle functions that those motions will govern, the enhanced vehicle key fob 58 can monitor the movement of the key fob 58. The processor 202 and/or memory device 204 can store a plurality of movement ranges for each defined bodily motion that, when detected, indicate with a reasonable certainty that the user is executing a particular defined bodily motion. The microprocessor 202 can initiate a period of monitoring the enhanced vehicle key fob 58 when the key fob 58 becomes relatively motionless. For instance, a user can hold the enhanced vehicle key fob 58 steadily in a hand for a moment and this relative non-movement can signal the processor 202 to begin monitoring movement of the key fob 58 and comparing that motion with defined bodily motions. The microprocessor 202 can end the period of monitoring when the enhanced vehicle key fob 58 is motionless again and/or begin a new period of monitoring. The method 300 proceeds to step 330.

At step 330, the vehicle function associated with the detected bodily motion is detected and controlled by the enhanced vehicle key fob 58. When the motion output from the accelerometer 210 is determined by the microprocessor 202 to fall within the movement ranges that identify a defined bodily motion, the microprocessor 202 can identify the defined bodily motion, access the one or more vehicle functions that are associated with the motion, and then control the vehicle function(s). Using the example discussed above, a user can grasp the enhanced vehicle key fob 58 holding it motionless for a moment, execute two up-and-down movements holding the key fob 58, and the key fob 58 can determine that the user movement falls within the movement ranges that define the two up-and-down movements. The microprocessor 202 can then determine that a vehicle door unlock function is associated with the detected movement and wirelessly send a command signal from the enhanced vehicle key fob 58 to the vehicle 12 commanding the vehicle telematics unit 30 to unlock the vehicle doors. Once the vehicle function (in this example, door unlocking) has been accomplished, the enhanced vehicle key fob 58 can confirm that the function has been controlled (e.g., the doors are now unlocked) by generating haptic feedback. The haptic feedback can be created by activating the vibrating electric motor 212. The method 300 then ends.

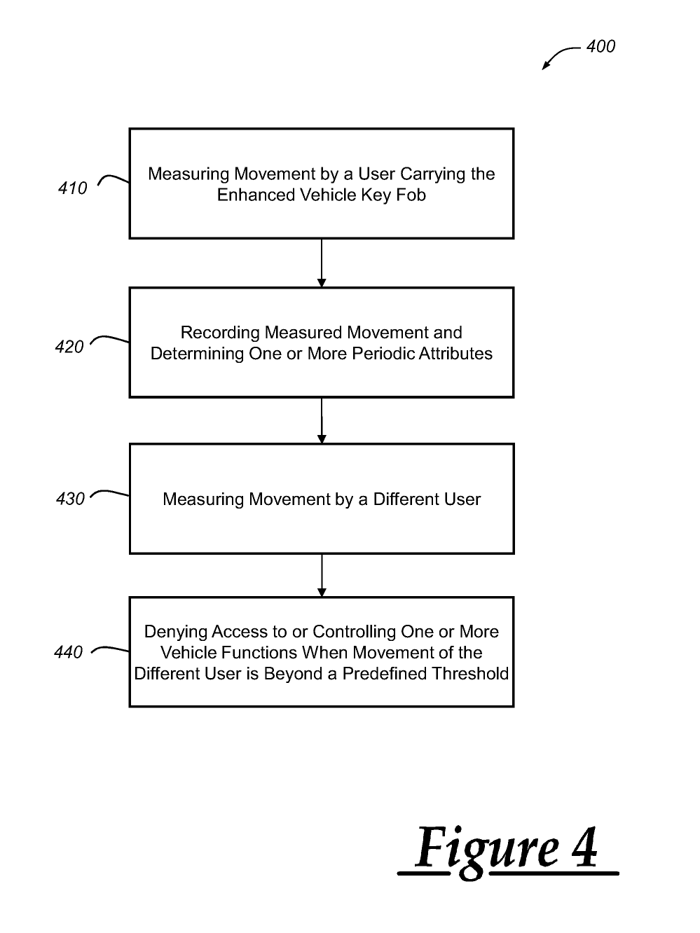

Turning to FIG. 4, another method 400 of using the enhanced vehicle key fob 58 is shown. The method 400 can authenticate a user of the enhanced vehicle key fob 58 and begins at step 410 by measuring movement by a user carrying the enhanced vehicle key fob 58 using the accelerometer 210 included with the vehicle key fob 58. As people walk, they move forward using a gait that can be as unique as a person's fingerprint. That is, each person has limbs, indeed bones that comprise limbs, of differing lengths and shapes. In addition, the muscles used to actuate these limbs are of different sizes and length and are attached to the bones at different points for each person. The unique limb/bone/muscle architecture creates a unique motion for each person when they walk and that individuality can be interpreted from output by the accelerometer 210. It is also possible to differentiate between male movements and female movements by calculating movement of the enhanced vehicle key fob 58 being located in a pocket versus a purse. In one example, a user of the enhanced vehicle key fob 58 can walk for a period of time and the accelerometer 210 can detect a defined range of up and down movement over a period of time and this detected movement can be quantified as a maximum y-axis movement, a minimum y-axis movement, as well as a time period between which the processor 202 outputs maximum y-axis measurements. In this example, the measurements are described solely in terms of time and y-axis measurements however, the method 400 can be modified so that x-axis measurements are measured with y-axis measurements or x, y, and z-axis measurement generated by the accelerometer 210 can be monitored. Generally speaking, any sub-combination of x-, y-, and z-axis measurements can be monitored. The method 400 proceeds to step 420.

At step 420, the measured movement of the user can be recorded at the enhanced vehicle key fob 58 and one or more periodic attributes of the recorded movement are determined. When a user or vehicle owner carries or wears the enhanced vehicle key fob 58, it can learn the unique periodic movements of the owner. The enhanced vehicle key fob 58 can monitor these unique movements over a period of time and record them at the key fob 58 using memory device 204. For instance, the enhanced vehicle key fob 58 can be initiated by the user to begin monitoring motion over a period of time. Using one of the switches 218, the user can initiate a learning period (e.g., 24 hours) and over this period the enhanced vehicle key fob 58 can record the output from the accelerometer 210. This recording of movement can include minimums and maximums along the x-, y-, or z-axes as well as time periods between these maximums and minimums. The recorded movement can be used to control access to the vehicle 12 and/or can be used to control vehicle function settings on the vehicle 12. For example, the recorded movement can be used to identify the user and a number of personalized settings, such as HVAC levels, seating positions, etc. It should also be appreciated that the enhanced vehicle key fob 58 can include the capability to remember the movement of more than one user and differentiate between these users. Once the unique movements have been established and the learning period has passed, the user or vehicle owner can lock the enhanced vehicle key fob 58 in various ways, such as by pressing the switches 218 in a user-defined sequence or by creating a password that is communicated to the key fob 58 wirelessly or via the external port 208. The method 400 proceeds to step 430.

At step 430, movement by a different user is measured using the accelerometer 210. The movement by the different user is compared to the periodic attributes of the recorded movement. Sometimes people other than the vehicle owner may use the enhanced vehicle key fob 58. These people could be valet workers or other family members, for instance. When these people use the enhanced vehicle key fob 58, it can be used to maintain or alter control of vehicle functions. In one example, after the learning period has expired and the enhanced vehicle key fob 58 has stored the recorded movement of one or more users, the key fob 58 can monitor movement over a second period of time, which can be initiated in response to the key fob 58 remaining motionless for some period (e.g., 30 minutes). When the enhanced vehicle key fob 58 begins detecting movement again, it can compare the minimum and maximum x-, y-, or z-axis movements and periods between the minimums and maximums with those recorded during the learning period and representing the stored users. The method 400 proceeds to step 440.

At step 440, access to one or more vehicle functions is denied when the movement by the different user is beyond a predefined threshold of the periodic attributes. When the movements measured during the learning period for stored users do not match those detected during movement afterward, the enhanced vehicle key fob 58 can be programmed to block access to the vehicle 12. In one example, the enhanced vehicle key fob 58 can block, deny access, or ask for additional security checks (such as a PIN or mechanical key) before access to the vehicle 12 when the movements do not match or are not within a predetermined threshold of each other. However, it is also possible to determine that the movements match a user different from the vehicle owner, such as a family member, and the enhanced vehicle key fob 58 can then wirelessly alter the settings of one or more vehicle functions in response to detecting the family member's use of the key fob 58. For example, the enhanced vehicle key fob 58 can wirelessly command the vehicle 12 through the vehicle telematics unit 30 to change seat positions, radio station presets, or temperature settings. The method 400 then ends.

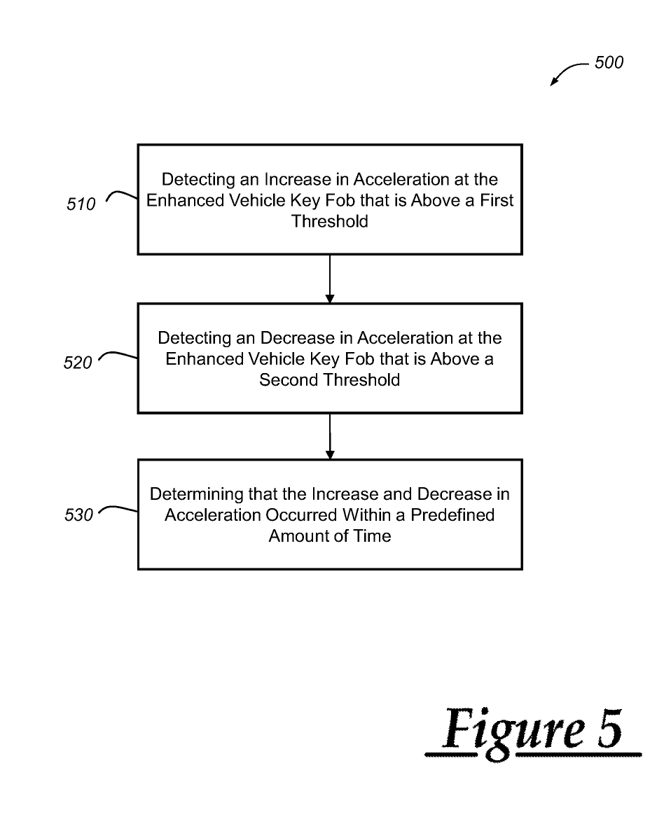

Turning to FIG. 5, another method 500 of using the enhanced vehicle key fob 58 is shown. The method 500 uses the accelerometer 210 of the enhanced vehicle key fob 58 to detect vehicle key loss. The method 500 begins at step 510 by detecting an increase in acceleration at the enhanced vehicle key fob 58 using the accelerometer 210 that is determined to be above a first threshold. When something is dropped, it begins to fall until it hits the ground. For example, if someone drops the enhanced vehicle key fob 58, it will move from a substantially-motionless state and then accelerate sharply as the key fob begins to free fall. The processor 202 can receive output from the accelerometer 210 measuring motion in the y-axis and be programmed to calculate the rate of change of y-axis motion. When the rate of change or the second derivative of y-axis motion output from the accelerometer 210 rises above a threshold, the processor 202 can determine that an increase in acceleration has occurred. The method 500 proceeds to step 510.

At step 520, a decrease in acceleration at the enhanced vehicle key fob 58 is detected using the accelerometer 210 and determined to be above a second threshold. A short time after the enhanced vehicle key fob 58 begins its fall it may also abruptly stop falling when it hits the ground. This motion can be detected using the accelerometer 210 and the processor 202 as a sharp decrease in acceleration. Using techniques similar to those discussed above with respect to step 510, the processor 202 can monitor y-axis movement using the accelerometer and determine movement reflective of the enhanced vehicle key fob 58 reaching the bottom of its fall on the floor. The method 500 proceeds to step 530.

At step 530, it is determined whether the increase and decrease in acceleration occurred both within a predefined amount of time. Increases and decreases in acceleration occurring as a result of dropping the enhanced vehicle key fob 58 occur within a short time of each other (e.g., <1 second). Thus, an isolated but sharp increase or decrease in acceleration of the enhanced vehicle key fob 58 alone may not be indicative of the key fob 58 falling. Instead, such isolated increased or decreases in acceleration could result from air travel or other motion. Thus, determining whether the combination of increase and decrease in acceleration within a predetermined time period can provide assurance that the enhanced vehicle key fob 58 indeed did fall rather that detect some other motion. If the enhanced vehicle key fob 58 detects motion meeting the thresholds for an increase in acceleration and a decrease in acceleration, as well as detecting this motion with the predetermined time interval, the key fob 58 can activate an alert that informs a user that the key fob 58 has been lost. This alert can be an audible noise, a visual flashing if the enhanced vehicle key fob 58 include a display, or both. The method 500 then ends.

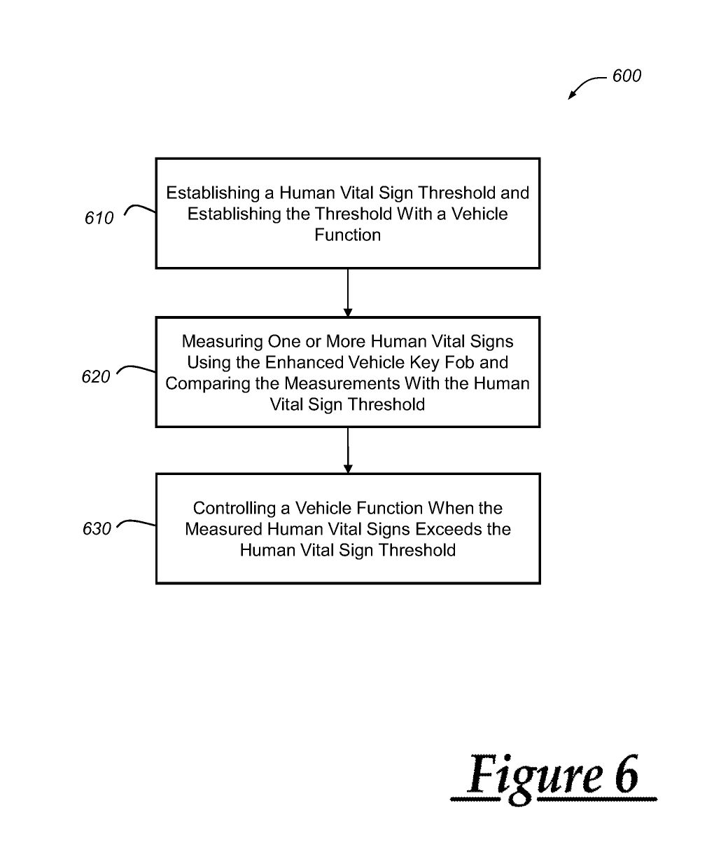

Turning to FIG. 6, another method 600 of using the enhanced vehicle key fob 58 is shown. The method 600 locally monitors human vital signs of an enhanced vehicle key fob user. The method 600 begins by establishing a human vital sign threshold and associating the human vital sign threshold with a vehicle function. Depending on the variety and number of sensors 214 included with the enhanced vehicle key fob 58, a number of human vital signs of the enhanced vehicle key fob user can be monitored. Human vital signs include body temperature, pulse rate, blood pressure, or other such measurable body metric. And thresholds can be established for each human vital sign of each enhanced vehicle key fob user. For example, the enhanced vehicle key fob 58 can include a sensor 214 that measures temperature of the enhanced vehicle key fob user and provides that information to the processor 202 of the enhanced vehicle key fob 58. A healthy temperature of the human body is 98.6° Fahrenheit (F). Upper and lower thresholds above and below 98.6° F. can be established that indicate that the enhanced vehicle key fob user is warmer or colder than ideal or normal. Similarly, ideal values of pulse rate, blood pressure, or other human vital signs can be determined and then upper and lower thresholds can then be established that surround those ideals. The upper and lower thresholds can each be viewed as a human vital sign threshold. In addition, a vehicle function that is related to the human vital sign can also be associated with that vital sign. For instance, using body temperature as an example of the monitored human vital sign, the vehicle HVAC system can be a vehicle function that is associated with that human vital sign. In this case, the enhanced vehicle key fob 58 can detect the temperature of the human body and if it is above/below ideal, the HVAC system can be controlled to increase or decrease its temperature. Or in another example, when the enhanced vehicle key fob user's heart rate is the human vital sign being measured, then the vehicle function can be the HVAC system control and/or control of the interior lighting levels. When the user's heart rate is below and ideal value, the HVAC system can be directed to lower the temperature in the vehicle 12 and also increase the amount of light provided by an instrument panel in an effort to increase the heart rate. The method 600 proceeds to step 620.

At step 620, one or more human vital signs are measured using the enhanced vehicle key fob 58 and compared with the established human vital sign threshold. The enhanced vehicle key fob 58 can store the upper and lower thresholds surrounding the ideal value for one or more human vital signs and compare the monitored human vital signs with these thresholds. For instance, the enhanced vehicle key fob 58 can monitor the body temperature of the enhanced vehicle key fob user using a sensor 214 that sends data to the processor 202. The processor 202 can then compare the sensor output to the upper and lower thresholds to determine whether or not the output exceeds those thresholds. The method 600 then proceeds to step 630.

At step 630, the vehicle function associated with the human vital sign threshold is controlled when the measured human vital sign exceeds the established human vital sign threshold. When the processor 202 determines that the monitored human vital sign is outside of either the upper or lower threshold, the processor 202 can access instructions for controlling a vehicle function associated with the monitored human vital sign. Using body temperature as an example, the sensor 214 can begin sending output to the processor 202 that falls outside of either the upper or lower threshold. When the monitored body temperature is above the upper threshold, then the processor 202 can generate a command to increase the cooling mechanism of the vehicle 12 and wirelessly transmit that command to the vehicle telematics unit 30 via a short-range wireless communication link. The vehicle 12 can receive this command and respond by controlling the vehicle HVAC system. Similarly, if the monitored body temperature is below the lower threshold, then the processor 202 can generate a command to increase the heating mechanism of the vehicle 12 and wirelessly transmit that command to the vehicle telematics unit 30 via a short-range wireless communication link. In another implementation, the enhanced vehicle key fob 58 can be wirelessly paired with the smartphone 57 and can transmit the monitored human vital sign(s) to a central facility, such as computer 18 or call center 20. For example, the human vital signs can be continually monitored during and after an accident and wirelessly transmitted to first responders using the vehicle telematics unit 30 or through the smartphone 57 by using the Bluetooth LE connection between the smartphone 57 and the enhanced vehicle key fob 58. The method 600 then ends.

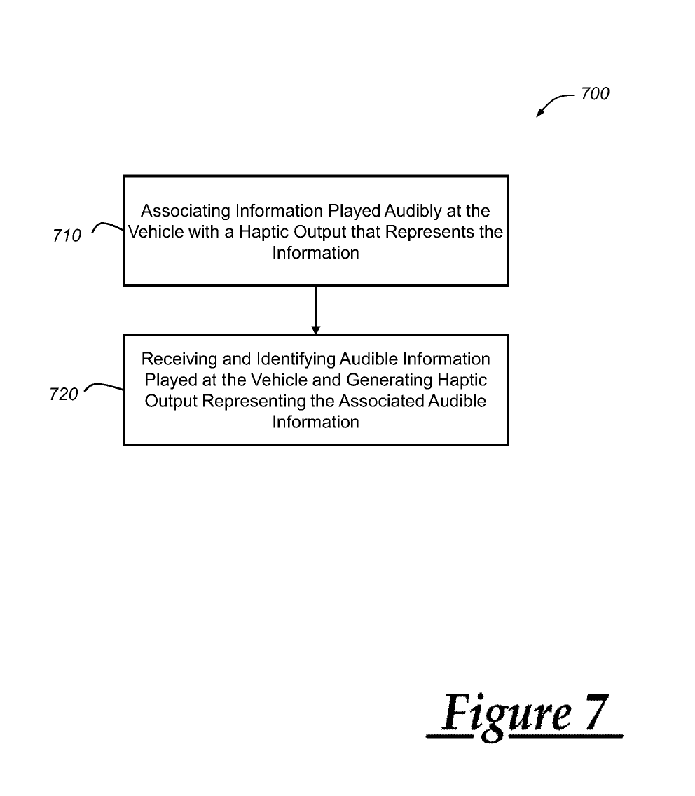

Turning to FIG. 7, yet another method 700 of using the enhanced vehicle key fob 58 is shown. The method 700 converts audio generated at the vehicle 12 into haptic information using the enhanced vehicle key fob 58 and begins at step 710 by associating information played audibly at the vehicle 12 with a haptic output that represents the information. The vehicle 12 can audibly play a number of recorded phrases or statements through a vehicle audio system 36. Often, these statements are recorded and stored at the vehicle 12 or are otherwise known by the vehicle 12 before they are played. These phrases or statements can also be stored at the enhanced vehicle key fob 58, which can use automatic speech recognition (ASR) techniques to detect the phrases/statements when they are played. The enhanced vehicle key fob 58 can include a microphone (not shown) to listen for the audibly played phrases/statements to occur. In addition, the enhanced vehicle key fob 58 can associate a haptic output with each phrase. For example, one of the statements that can be audibly played by the vehicle 12 is “low fuel” when fuel levels fall below a predetermined level. The enhanced vehicle key fob 58 can understand the “low fuel” message and associate with it a particular haptic output, such as three one-second vibrations that can be generated by the vibrating electric motor 212. In addition, the vehicle 12 can include a number of safety features, such as blind-spot detection or an imminent collision alert. Each of these safety features often have audible alerts but can also be identified using a haptic output. These safety features can provide haptic output in a seat. But providing the haptic output at the enhanced vehicle key fob 58 is more effective because it is closer to the user's skin and can provide a more direct path to convey the haptic output. The method 700 proceeds to step 720.

At step 720, audible information played at the vehicle 12 is received at the enhanced vehicle key fob 58, identified, and the haptic output representing the associated audible information is generated. When the vehicle 12 generates an audible message, the enhanced vehicle key fob 58 can perform ASR on the message and determine whether or not the audible message is one stored at the key fob 58 and/or associated with a particular haptic feedback. Using the “low fuel” message discussed with respect to step 710, the enhanced vehicle key fob 58 can detect this message in the vehicle 12, determine that the “low fuel” message has a haptic feedback of three one-second vibrations, and then direct the vibrating electric motor 212 to activate for the three one-second vibrations. The user holding or wearing the enhanced vehicle key fob 58 can then feel the vibrations and without hearing the audible low fuel message associate the vibrations with the low fuel condition of the vehicle 12. It should be appreciated that this can also be implemented without ASR. In that case, the vehicle 12, such as through its vehicle telematics unit 30, can generate a short-range wireless signal each time a safety feature generates an audible alert instructing the enhanced vehicle key fob 58 to generate haptic feedback. The method 700 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. An enhanced vehicle key fob, comprising:
a processor that is coupled to a power source and an accelerometer that measures the acceleration of the enhanced vehicle key fob and outputs the measurement to the processor, wherein the enhanced vehicle key fob controls a vehicle function of a vehicle using the output of the accelerometer.

2. The enhanced vehicle key fob of claim 1, further comprising a vibrating electric motor providing haptic feedback that confirms a vehicle function has been controlled.

3. The enhanced vehicle key fob of claim 1, further comprising one or more sensors for measuring human vital signs.

4. The enhanced vehicle key fob of claim 1, including one or more straps that secure the enhanced vehicle key fob to a user.

5. The enhanced vehicle key fob of claim 1, wherein the processor communicates using Bluetooth low energy (LE) wireless communication protocols.

6. The enhanced vehicle key fob of claim 1, wherein the enhanced vehicle key fob sends data to a smartphone via a short-range wireless link.

7. The enhanced vehicle key fob of claim 6, wherein the smartphone determines a range to the enhanced vehicle key fob based on the strength of a signal broadcast by the enhanced vehicle key fob.

8. The enhanced vehicle key fob of claim 1, further comprising an enclosure no more than 40 millimeters long and no more than 40 millimeters wide.

9. The enhanced vehicle key fob of claim 1, further comprising a gyroscope providing angular movement measurements to the processor.

10-20. (canceled)

21. A method of using an enhanced vehicle key fob having an accelerometer to detect enhanced vehicle key fob loss, comprising the steps of:
(a) detecting that an increase in acceleration at the enhanced vehicle key fob using the accelerometer is above a first threshold;
(b) detecting that a decrease in acceleration at the enhanced vehicle key fob using the accelerometer is above a second threshold;
(c) determining that both the increase and decrease in acceleration occurred within a predefined amount of time; and
(d) activating an alert at the enhanced vehicle key fob in response to steps (a)-(c) that informs a user that the vehicle key fob has been lost.

22. The method of claim 21, wherein the acceleration is detected using an accelerometer, a gyroscope, or both included with the enhanced vehicle key fob.

23. The method of claim 21, wherein the predefined amount of time is less than one second.

24. A method of locally monitoring human vital signs of a vehicle occupant using a enhanced vehicle key fob, comprising the steps of:
(a) establishing a human vital sign threshold;
(b) associating the human vital sign threshold with a vehicle function;
(c) measuring one or more human vital signs using the enhanced vehicle key fob;
(d) comparing the measured human vital sign with the established human vital sign threshold; and
(e) controlling the vehicle function associated with the human vital sign threshold when the measured human vital sign exceeds the established human vital sign threshold.

25. A method of converting audio generated at a vehicle into haptic information using an enhanced vehicle key fob, comprising the steps of:
(a) associating information played audibly at the vehicle with a haptic output that represents the information;
(b) receiving at the enhanced vehicle key fob a signal indicating audible information is played at the vehicle; and
(c) generating the haptic output representing the audible information at the enhanced vehicle key fob in response to step (b).
